(19) United States
(12) Patent Application Publication
(10) Pub. No.: US 2011/0311888 A1
(43) Pub. Date: Dec. 22, 2011

(54) ELECTRODES AND PRODUCTION AND USE THEREOF

(75) Inventors: Arnd GARSUCH, Ludwigshafen (DE); Alexander Panchenko, Ludwigshafen (DE); Andrey Karpov, Mannheim (DE); Rüdiger Schmidt, Ludwigshafen (DE); Sabine Huber, Limburgerhof (DE)

(73) Assignee: BASF SE, Ludwigshafen (DE)

(21) Appl. No.: 13/165,117

(22) Filed: Jun. 21, 2011

Related U.S. Application Data
(60) Provisional application No. 61/357,127, filed on Jun. 22, 2010.

(51) Int. Cl. H01M 8/22

(52) U.S. Cl. 429/405

(57) ABSTRACT

Electrodes, comprising
(A) a solid medium through which gas can diffuse,
(B) at least one electrically conductive, carbonaceous material,
(C) at least one organic polymer,
(D) at least one compound of the general formula (I)

M¹ₐM²_{b}M³_{c}M⁴_{d}HₑO_{f} (I)
in particulate form, where the variables are each defined as follows:
M¹ is selected from Mo, W, V, Nb and Sb,
M² is selected from Fe, Ag, Cu, Ni, Mn and lanthanoids,
M³ is selected from B, C, N, Al, Si, P and Sn,
M⁴ is selected from Li, Na, K, Rb, Cs, NH₄, Mg, Ca and Sr,
a is in the range from 1 to 3,
b is in the range from 0.1 to 10,
c is in the range from zero to one,
d is in the range from zero to one,
e is in the range from zero to 0.5,
f is in the range from 1 to 28,
   and wherein compound of the general formula (I) has a BET surface area in the range from 1 to 300 m²/g.

The present invention relates to electrodes comprising
(A) a solid medium through which gas can diffuse,
(B) at least one electrically conductive, carbonaceous material,
(C) at least one organic polymer,
(D) at least one compound of the general formula (I)

M¹ₐM²_{b}M³_{c}M⁴_{d}HₑO_{f} (I)
in particulate form, where the variables are each defined as follows:
M¹ is selected from Mo, W, V, Nb and Sb,
M² is selected from Fe, Ag, Cu, Ni, Mn and lanthanoids,
M³ is selected from B, C, N, Al, Si, P and Sn,
M⁴ is selected from Li, Na, K, Rb, Cs, Mg, Ca and Sr,
a is in the range from 1 to 3,
b is in the range from 0.1 to 10,
c is in the range from zero to one,
d is in the range from zero to one,
e is in the range from zero to 0.5,
f is in the range from 1 to 28,
   and wherein compound of the general formula (I) has a BET surface area in the range from 1 to 300 m²/g.

The present invention further relates to the use of inventive electrodes in electrochemical cells, for example in lithium air batteries. The present invention further relates to a process for production of inventive electrochemical cells and to a process for production of inventive electrodes.

For many years there has been a search for alternatives to conventional electrochemical cells in which charge transport is undertaken by more or less hydrated protons, and for which the maximum voltage is limited. One alternative storage medium for electrical energy in this context is lithium ion batteries, in which charge transport is ensured by lithium ions in nonaqueous solvents.

Generally, it is desired that electrochemical cells have a high energy density.

One remedy is offered by lithium-air batteries. In one typical embodiment, lithium is oxidized with atmospheric oxygen in a nonaqueous electrolyte to form an oxide or a peroxide, i.e., to form Li₂O or Li₂O₂. The energy released is utilized electrochemically. Batteries of this kind can be recharged by reduction of the metal ions formed in the discharge. For this purpose, the use of gas diffusion electrodes (GDEs) as the cathode is known. Gas diffusion electrodes are porous and have bifunctional actions. Metal-air batteries must enable the reduction of the atmospheric oxygen to oxide or peroxide ions in the course of discharging, and the oxidation of the oxide or peroxide ions to oxygen in the course of charging. For this purpose, for example, the construction of gas diffusion electrodes on a carrier material composed of finely divided carbon is known, said carrier material comprising one or more catalysts for catalysis of the oxygen reduction or of the oxygen evolution.

It is known for example from A. Débart et al., Angew. Chem. 2008, 120, 4597 (Angew. Chem. Int. Ed. Engl. 2008, 47, 4521) that catalysts are required for such gas diffusion electrodes. Débart et al. mention Co₃O₄, Fe₂O₃, CuO and CoFe₂O₄, and they report α-MnO₂ nanowires and compare them with MnO₂, β-MnO₂, γ-MnO₂, λ-MnO₂, Mn₂O₃ and Mn₃O₄.

All the materials known from the prior art cited above can still be improved with respect to at least one of the following properties: electrocatalytic activity, resistance to chemicals, electrochemical corrosion resistance, mechanical stability, good adhesion on the carrier material, and low interaction with conductive carbon black and binder.

Accordingly, the electrodes defined at the outset have been found.

The electrodes defined at the outset, also referred to as inventive electrodes in the context of the present invention, comprise
(A) a solid medium through which gas can diffuse, also referred to in the context of the present invention as medium (A) or carrier (A),
(B) at least one electrically conductive, carbonaceous material,
(C) at least one organic polymer, and
(D) at least one compound of the general formula (I)

M¹ₐM²_{b}M³_{c}M⁴_{d}HₑO_{f} (I)
in particulate form, where the variables are each defined as follows:
M¹ is selected from Mo, W, V, Nb and Sb,
M² is selected from Fe, Ag, Cu, Ni, Mn and lanthanoids,
M³ is selected from B, C, N, Al, Si, P and Sn,
M⁴ is selected from Li, Na, K, Rb, Cs, NH₄, Mg, Ca and Sr,
a is in the range from 1 to 3,
b is in the range from 0.1 to 10,
c is in the range from zero to one,
d is in the range from zero to one,
e is in the range from zero to 0.5,
f is in the range from 1 to 28,
   and wherein compound of the general formula (I) has a BET surface area in the range from 1 to 300 m²/g.

Solid media through which gas can diffuse, also referred to as media (A) for short, in the context of the present invention are preferably considered to be those porous bodies through which oxygen or air can diffuse even without application of elevated pressure, for example metal meshes and gas diffusion media composed of carbon, especially activated carbon, and carbon on metal mesh. The gas permeability can be determined, for example by the Gurley method in analogy to the measurement of the gas permeability of paper or paperboard.

In one embodiment of the present invention, medium (A) has a porosity in the range from 20 to 1000 seconds for 10 cm³ of air, preferably 40 to 120 seconds/10 cm³. In this context, seconds represent “Gurley seconds”.

In one embodiment of the present invention, air or atmospheric oxygen can flow essentially unhindered through medium (A).

In one embodiment of the present invention, medium (A) is a medium which conducts the electrical current.

In a preferred embodiment of the present invention, medium (A) is chemically inert with respect to the reactions which proceed in an electrochemical cell in standard operation, i.e. in the course of charging and in the course of discharging.

In one embodiment of the present invention, medium (A) has an internal BET surface area in the range from 20 to 1500 m²/g, which is preferably referred to as the apparent BET surface area.

In one embodiment of the present invention, medium (A) is selected from metal meshes, for example nickel meshes or tantalum meshes. Metal meshes may be coarse or fine.

In another embodiment of the present invention, medium (A) is selected from electrically conductive fabrics, for example mats, felts or fibrous nonwoven webs of carbon which comprise metal filaments, for example tantalum filaments or nickel filaments.

In one embodiment of the present invention, medium is selected from gas diffusion media, for example activated carbon, aluminum-doped zinc oxide, antimony-doped tin oxide or porous carbides or nitrides, for example WC, Mo₂C, Mo₂N, TiN, ZrN or TaC.

Inventive electrodes further comprise at least one electrically conductive, carbonaceous material (B), also referred to in the context of the present invention as conductive carbon (B).

Conductive carbon (B) can be selected, for example, from graphite, activated carbon, carbon black, carbon nanotubes, graphene or mixtures of at least two of the aforementioned substances.

In one embodiment of the present invention, conductive carbon (B) is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In the case that medium (A) and conductive carbon (B) are each selected as activated carbon, medium (A) and conductive carbon (B) may be chemically different or preferably the same.

Conductive carbon (B) may be present, for example, in particles which have a diameter in the range from 0.1 to 100 mm, preferably 2 to 20 μm.

In one variant, conductive carbon (B) is partially oxidized carbon black.

In one embodiment of the present invention, conductive carbon (B) comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes are obtainable by processes known per se. For example, a volatile carbon-containing compound, for example methane or carbon monoxide, acetylene or ethylene, or a mixture of volatile carbon-containing compounds, for example synthesis gas, can be decomposed in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon-containing compounds in a light arc, specifically in the presence or absence of a decomposition catalyst.

In one embodiment, the decomposition of volatile carbon-containing compound or carbon-containing compounds is performed in the presence of a decomposition catalyst, for example Fe, Co or preferably Ni.

In the context of the present invention, graphene is understood to mean almost ideally or ideally two-dimensional hexagonal carbon crystals with a structure analogous to single graphite layers.

In one embodiment of the present invention, electrically conductive carbon (B) and especially carbon black has a BET surface area in the range from 20 to 1500 m²/g, measured to ISO 9277.

Inventive electrodes comprise at least one organic polymer, referred to as polymer (C) or binder (C) for short. In this context, the term “organic polymer” also includes organic copolymers and refers to polymeric compounds in which the main chain contains principally carbon atoms, i.e. at least 50 mol %, and which can be prepared by free-radical polymerization, anionic, cationic or catalytic polymerization, or by polyaddition or polycondensation.

Particularly suitable polymers (C) can be selected, for example, from (co)polymers obtainable by anionic, catalytic or free-radical (co)polymerization, especially from polyethylene, polyacrylonitrile, polybutadiene, polystyrene, polyethyleneimine, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (polymer (C)) is polybutadiene.

Other suitable polymers (C) are selected from polyethylene oxide (PEO), cellulose, carboxymethylcellulose, polyimides and polyvinyl alcohol.

In one embodiment of the present invention, polymer (C) is selected from those (co)polymers which have a mean molecular weight M_{w} in the range from 50,000 to 1,000,000 g/mol, preferably to 500,000 g/mol.

Polymers (C) may be crosslinked or uncrosslinked (co)polymers.

In a particularly preferred embodiment of the present invention, polymers (C) are selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable polymers (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Further suitable polymers (C) are polysulfones, especially polyether sulfones.

Inventive electrodes further comprise at least one compound of the general formula (I)

M¹ₐM²_{b}M³_{c}M⁴_{d}HₑO_{f} (I)
in particulate form, also referred to as compound (D) for short, where the variables are each defined as follows:
M¹ is selected from Mo, W, V, Nb and Sb, preference being given to V, Mo and W,
M² is selected from Fe, Ag, Cu, Ni, Mn and lanthanoids, preference being given to Fe, Ag, and among the lanthanoids La and Ce,
M³ is selected from B, C, N, Al, Si, P and Sn, preference being given to P and Si,
M⁴ is selected from Li, Na, K, Rb, Cs, NH₄, Mg, Ca and Sr, preference being given to NH₄, Li, K and Na,
a is in the range from 1 to 3, preferably 1,
b is in the range from 0.1 to 10, preferably 0.3 to 3,
c is in the range from zero to one, preferably to 0.2,
d is in the range from zero to one, preferably to 0.2,
e is in the range from zero to 0.5, preferably to 0.1,
f is in the range from 1 to 28,
   and wherein compound of the general formula (I) has a BET surface area in the range from 1 to 300 m²/g, preferably from 1 to 100 m²/g, more preferably from 1 to 50 m²/g.

In one embodiment of the present invention, variable f is selected such that compound (D) is electrically uncharged.

In another embodiment of the present invention, variable f is selected such that compound (D) is not electrically uncharged, for example less than zero to −2.

When variable e is selected unequal to zero, the hydrogen is preferably present in hydroxide ions in compound (D).

In one embodiment of the present invention, M¹, M², M³ or M⁴ in compound (D) is selected from mixtures of at least two elements. For example, M² can be selected from mixtures of Fe and Ag. For example M¹ can be selected from mixtures of V and Mo.

In one embodiment of the present invention, compound (D) is selected from mixed oxides and heteropolyacids and salts thereof, for example ammonium or alkali metal salts. Compound (D) is preferably selected from mixed oxides.

In one embodiment of the present invention, compound (D) is selected from Fe—Ag—X—O, Fe—V—X—O, Ag—V—X—O, Ce—X—O and Fe—X—O, where X is selected from tungsten and preferably molybdenum.

In one embodiment of the present invention, the Fe—Ag—X—O in compound (I) is selected from compounds of the general formula (II)

XₐFe_{b1}Ag_{b2}O_{f} (II)
where the sum of the variables b1 and b2 is in the range from 0.1 to 10, preferably 0.3 to 3, and the remaining variables are each as defined above.

In one embodiment of the present invention, Fe—V—X—O is selected from compounds of the general formula (III)

Vₐ₁Xₐ₂Fe_{b}O_{f} (III)
where the sum of the variables a1 and a2 is in the range from 1 to 3, and the remaining variables are each as defined above.

In one embodiment of the present invention, Ag—V—X—O is selected from compounds of the general formula (IV)

Vₐ₁Xₐ₂Ag_{b}O_{f} (IV)
where the variables are each as defined above.

In one embodiment of the present invention, Ce—X—O is selected from compounds of the general formula (V)

XₐCe_{b}O_{f} (V)
where the variables are each as defined above.

Compound (D) is in particulate form. In this case, the particles may be of regular or irregular shape and have, for example, a spherical shape, platelet shape, needle shape, or irregular shape.

In one embodiment of the present invention, compound (D) has a mean primary particle diameter in the range from 10 to 50 nm. The mean primary particle diameter can be determined by microscopy, for example by scanning electron microscopy or by transmission electron microscopy (TEM).

In one embodiment of the present invention, compound (D) is in the form of agglomerated particles, in which case the agglomerates may have a mean diameter of 20 nm to 100 μm. In this case, agglomerates may have such an appearance that particles of compound (D) may be composed, for example, of at least two to several thousand primary particles.

In one embodiment of the present invention, compound (D) has a BET surface area in the range from 1 to 300 m²/g, measured to ISO 9277.

In one embodiment of the present invention, compound (D) has a bimodal particle diameter distribution.

In one embodiment of the present invention, inventive electrodes comprise mixtures of at least two different compounds (D).

In one embodiment of the present invention, inventive electrodes comprise
in the range from 20 to 80% by weight, preferably 35 to 75% by weight, of electrically conductive carbon (B),
in the range from 5 to 50% by weight, preferably to 20% by weight, of polymer (C), and
in the range from 0.5 to 25% by weight, preferably 5 to 15% by weight, of compound (D)
based on overall electrode.

In one embodiment of the present invention, inventive electrodes may have further components. Suitable further components are, for example, solvents, which are understood to mean organic solvents, especially isopropanol, N-methylpyrrolidone, N,N-dimethylacetamide, amyl alcohol, n-propanol or cyclohexanone. Further suitable solvents are organic carbonates, cyclic or noncyclic, for example diethyl carbonate, ethylene carbonate, propylene carbonate, dimethyl carbonate and ethyl methyl carbonate, and also organic esters, cyclic or noncyclic, for example methyl formate, ethyl acetate or γ-butyrolactone (gamma-butyrolactone), and also ethers, cyclic or noncyclic, for example 1,3-dioxolane.

In addition, inventive electrodes may comprise water.

Inventive electrodes may be configured in various forms. For instance, in the case that carrier (A) is selected from metal meshes, it is possible that the form of inventive electrodes is defined essentially by the form of the metal grid.

In addition, in the case that carrier (A) is selected from activated carbon, it is possible that, in the case of finely divided activated carbon—for example with a mean particle diameter in the range from 0.1 to 100 μm—the electrode is applied as a formulation, for example as a paste, to a metal mesh, a gas diffusion medium composed of carbon or a gas diffusion medium composed of carbon on a metal mesh.

The present invention further provides for the use of inventive electrodes in electrochemical cells, for example in non-rechargeable electrochemical cells, which are also referred to as primary batteries, or in rechargeable electrochemical cells, which are also referred to as secondary batteries. The present invention further provides a process for producing electrochemical cells using at least one inventive electrode. The present invention further provides electrochemical cells comprising at least one inventive electrode.

In a preferred embodiment of the present invention, inventive electrochemical cells are lithium-air batteries.

Inventive electrochemical cells may have further constituents, for example a housing which may be of any shape, especially the shape of cylinders, disks or cuboids, and also at least one counterelectrode. The counterelectrode comprises, as an essential constituent, a metal in elemental form, for example pure lithium or a lithium alloy, for example lithium-tin alloy or lithium-silicon alloy or lithium-tin-silicon alloy.

Inventive electrochemical cells may further comprise at least one separator which separates the differently charged electrodes mechanically from one another, thus preventing a short circuit. Suitable separators are polymer films, especially porous polymer films, which are unreactive toward lithium in the elemental state and the electrolyte in inventive electrochemical cells. Particularly suitable materials for separators are polyolefins, especially porous polyethylene films and porous polypropylene films.

Polyolefin separators, especially polyethylene or polypropylene separators, may have a porosity in the range from 35 to 45%. Suitable pore diameters are, for example, in the range from 30 to 500 nm.

In another embodiment of the present invention, separators can be selected from PET nonwovens filled with inorganic particles. Such separators may have a porosity in the range from 40 to 55%. Suitable pore diameters are, for example, in the range from 80 to 750 nm.

Glass fiber reinforced paper is also suitable.

To produce inventive electrochemical cells, the procedure may, for example, be to combine inventive electrode, separator and counterelectrode with one another and to introduce them into a housing with any further components.

Inventive electrochemical cells may further comprise at least one electrolyte, which is a combination of at least one solvent and at least one salt-like compound or a salt.

In one embodiment of the present invention, inventive electrical cells comprise at least one nonaqueous solvent which can be room temperature liquid or solid, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in polymerized form. Polyalkylene glycols are preferably doubly methyl- or ethyl-capped polyalkylene glycols.

The molecular weight M_{w} of suitable polyalkylene glycols and especially of suitable polyethylene glycols can be at least 400 g/mol.

The molecular weight M_{w} of suitable poiyalkylene glycols and especially of suitable polyethylene glycols can be up to 5,000,000 g/mol and preferably up to 2,000,000 g/mol.

Examples of suitable noncyclic ethers are for example diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are for example dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (VI) and (VII)

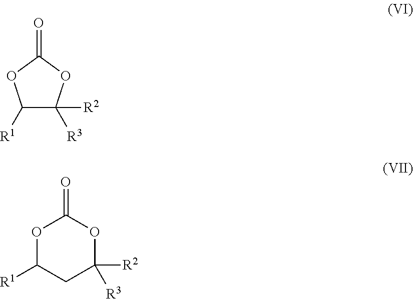

in each of which R¹, R² and R³ can be the same or different and are selected from hydrogen and C₁-C₄-alkyl, for example methyl, ethyl, n-propyl, isopropyl, n-butyl, isobutyl, sec-butyl and tert-butyl, although R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (VIII).

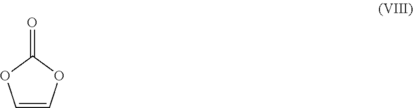

The solvent(s) are preferably used in the so-called water-free state, i.e. at a water content in the range from 1 ppm to 0.1% by weight, as can be determined by Karl Fischer titration for example.

Examples of salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:
m=1, when X is selected from oxygen and sulfur,
m=2, when X is selected from nitrogen and phosphorus, and
m=3, when X is selected from carbon and silicon.

Preferred conducting salts are selected from LiC(CF₃SO₂)₃, LiN(CF₃SO₂)₂, LiPF₆, LiBF₄, LiClO₄, and particular preference is given to LiPF₆ and LiN(CF₃SO₂)₂.

Examples of suitable solvents are especially propylene carbonate, ethylene carbonate, ethyl methyl carbonate, diethyl carbonate and mixtures of at least two of the aforementioned solvents, especially mixtures of ethylene carbonate with ethyl methyl carbonate or diethyl carbonate.

In one embodiment of the present invention, inventive electrochemical cells may comprise a further electrode, for example as a reference electrode. Suitable further electrodes are, for example, lithium wires.

The present invention further provides a process for producing inventive electrodes, also referred to hereinafter as inventive production process. To perform the inventive production process, the procedure may be to apply
(B) at least one electrically conductive, carbonaceous material,
(C) at least one organic polymer and
(D) at least one compound of the general formula (I) in particulate form with a BET surface area in the range from 1 to 300 m²/g
   in one or more steps to
(A) a solid medium through which gas can diffuse.

The procedure may specifically be to apply
(B) at least one electrically conductive, carbonaceous material,
(C) at least one organic polymer and
(D) at least one compound of the general formula (I) in particulate form with a BET surface area in the range from 1 to 300 m²/g,
   in the form of aqueous or solvent-based ink or preferably aqueous paste or preferably aqueous dough to
(A) a solid medium through which gas can diffuse.

Compound of the formula (I) is as described above. The remaining variables are likewise as described above.

It is also possible that compound (D) is first treated, for example coated, with electrically conductive carbon (B), and then mixed with polymer (C) and applied to carrier (A).

Another possibility comprises first applying
(B) at least one electrically conductive, carbonaceous material,
(C) at least one organic polymer and
(D) at least one compound of the general formula (I) in particulate form with a BET surface area in the range from 1 to 300 m²/g
   in the form of aqueous or solvent-based ink or preferably aqueous paste to a separator, for example by spraying, and then combining with
(A) a solid medium through which gas can diffuse, for example a metal mesh.

The application can be accomplished, for example, by spraying, for example spraying on or atomization, and also knife-coating, printing, or by pressing. In the context of the present invention, atomization also includes application with the aid of a spray gun, a method frequently also referred to as “airbrush method” or “airbrushing” for short.

Performance of the inventive production process proceeds, for example, from one or more compounds (D).

Compound (D) can be prepared, for example, by mixing suitable compounds of M¹, of M² and optionally of M³ and/or M⁴ with one another, for example in dry form or as a solution or suspension. Preference is given to selecting the ratios of the compounds of M¹, of M² and optionally of M³ and/or M⁴ in the stoichiometry of M¹, M², any M³ and M⁴ in compound (D). The mixture obtained in this way is subsequently treated thermally; for example it can be calcined, for example at temperatures in the range from 250 to 1000° C., preferably from 300 to 800° C. The calcination can be performed under inert gas or under an oxidative atmosphere, for example air (or another mixture of inert gas and oxygen). The duration of the calcination may be a few minutes to a few hours.

Suitable starting materials useful for preparation of compound (D) include oxides, hydroxides or oxohydroxides of M¹, M², M³ and/or M⁴. Further such compounds of M¹, M², M³ and/or M⁴ which are useful are those which react as a result of heating, in the presence or in the absence of oxygen, to give oxides, hydroxides or oxohydroxides.

The starting materials can be mixed to prepare compound (D) in dry or wet form. If performance in dry form is desired, the starting materials for preparation of compound (D) can be used in the form of fine powder and, after mixing and optional compaction, subjected to calcination. However, preference is given to effecting the intimate mixing in wet form. Typically, this involves mixing the starting materials for preparation of compound (D) with one another in the form of aqueous solutions and/or suspensions.

Particularly good mixtures of starting materials for preparation of compound (D) can be obtained by proceeding exclusively from compounds of M¹, M², M³ and/or M⁴ in dissolved form and precipitating compounds of M¹, M², M³ and/or M⁴. The aqueous material thus obtainable is dried subsequently, preferably at temperatures in the range from 100 to 150° C. A very particularly preferred drying method is spray drying, especially at exit temperatures in the range from 100 to 150° C.

Before, during or preferably after the thermal treatment, steps to establish the desired particle size of compound (D) can be undertaken, for example screening, grinding or classifying.

In an optional step, compound (D) can be treated, for example coated, with an electrically conductive carbon (B). To perform such a treatment, it is possible, for example, to mix compound (D) intensively with an electrically conductive carbon (B), for example to grind them. Mills, for example, are suitable for grinding, especially ball mills.

In another variant of the optional treatment of compound (D) with an electrically conductive carbon (B), it is possible to deposit carbon on compound (D), for example by decomposition of organic compounds.

This is followed by mixing with polymer (C) which can be added, for example, in the form of an aqueous dispersion or of pellets.

In another embodiment, compound (D), electrically conductive carbon (B) and polymer (C), which can be added for example in the form of an aqueous dispersion or pellets, are mixed in one step, for example by stirring the corresponding solids, optionally with one or more organic solvents or with water. For mixing, it is possible, for example, to use stirred apparatus such as stirred tanks, or mills, for example ball mills and especially stirred ball mills. In other embodiments, use is made of ultrasound, for example with the aid of a sonotrode. This gives a preferably aqueous formulation.

Subsequently, the desired properties of preferably aqueous formulation to be applied are established, for example, the viscosity or the solids content.

In the context of the present invention, those preferably aqueous formulations which have a solids content in the range from 0.5 to 25% are referred to as ink. Those preferably aqueous formulations which a solids content greater than 25% are referred to as paste.

In one embodiment of the present invention, the preferably aqueous formulation comprises at least one surfactant. Surfactants in the context of the present invention are surface-active substances. Surfactants can be selected from cationic, anionic and preferably nonionic surfactants.

Subsequently, a medium (A) or a carrier (A) is provided, to which the preferably aqueous formulation or the preferably aqueous formulations which comprise(s) electrically conductive carbon (B), polymer (C) and compound (D) is/are applied in one or more steps. The application can be effected, for example, by pressing, spraying, especially with a spray gun, and also knife-coating or preferably printing.

In another embodiment of the present invention, mixtures of the solvent-free electrically conductive carbon (B), polymer (C) and compound (D) components can be compressed with one another, for example at pressures in the range from 30 to 300 bar and temperatures in the range from 150 to 320° C. For this purpose, it is possible to proceed from a paste, preferably from an aqueous paste, the layer height of which can be adjusted with the aid of shims, by rolling and cutting to size, and apply it to the medium (A) in question.

The application can be followed by fixing, for example, by thermal treatment, especially by treatment at a temperature in the range from 150 to 350° C., especially at a temperature which corresponds approximately to the glass transition temperature of polymer (C). In this case, it is preferred, for example, to select the temperature within the range from 125 to 175° C., preferably about 150° C., when vinylidene fluoride-hexafluoropropylene copolymers are selected as polymer (C). In another variant, the temperature selected is 175 to 225° C., preferably about 200° C. and the polymer (C) selected is polyvinylidene fluoride. In another variant, the temperature selected is 300 to 350° C., preferably 320 to 325° C. and the polymer (C) selected is polytetrafluoroethylene.

In another embodiment of the present invention, thermal fixing steps are omitted.

In one variant it is possible to fix mechanically, preferably by calendering.

This gives an inventive electrode which can be combined with further constituents to give inventive electrochemical cells.

This gives inventive electrochemical cells with very good properties overall.

A further aspect of the present invention is that of formulations, also referred to as inventive formulations for short, comprising at least one organic solvent or water and
(B) at least one electrically conductive, carbonaceous material,
(C) at least one organic polymer and
(D) at least one mixed oxide which comprises molybdenum or tungsten and at least one element selected from Fe, Ag, a lanthanoid and V.

Examples of suitable organic solvents are N-methylpyrrolidone, cyclohexanone and N,N-dimethylacetamide, preference being given to N-methylpyrrolidone.

Aqueous formulations are preferred.

Electrically conductive carbon (B), polymer (C) and compound (D) have been defined above.

In one embodiment of the present invention, inventive, preferably aqueous formulations comprise at least one further constituent selected from surfactants, thickeners and defoamers.

In one embodiment of the present invention, inventive, preferably aqueous formulations may have a solids content in the range from 0.5 to 60%.

The invention is illustrated by working examples.

General preliminary remark: in the context of the present invention, figures in percent relate to percent by weight, unless explicitly stated otherwise.

### I. Production of an Aqueous Formulation

I.1 Production of an aqueous ink, WF1.1

The following were mixed together in a ball mill (Pulveristeette 6 from Fritsch): balls (diameter 10 mm),

70 g of carbon black (B.1), commercially available as Ketjen® Black from Akzo, BET surface area 850 m²/g (measured to ISO 9277), mean particle diameter: 10 μm.

14.24 g of MoVFeO₇ (D.1) or (III.1)

180 ml of water

The contents were ground at 300 rpm for 30 minutes. Thereafter, the balls were separated off. Then, 15.7 g of an aqueous dispersion of polytetrafluoroethylene (C.1) having a solids content of 60% were added followed by 15 minutes of stirring on a magnetic stirrer . A 16 g quantity of n-propanol was added to obtain an inventive ink hereinafter also referred to as WF1.1.

### I.2 Production of an Aqueous Ink, WF1.2

The following were mixed together in a ball mill (Pulveristeette 6 from Fritsch):

balls (diameter 10 mm),

70.6 g of carbon black (B.1), commercially available as Ketjen® Black from Akzo, BET surface area 850 m²/g (measured to ISO 9277), mean particle diameter: 10 μm.

14.2 g of Mo_{1.2}V_{0.8}Fe_{1.6}O₈ (D.2) or (III.2)

15.7 g of an aqueous dispersion of polytetrafluoroethylene (C.1) having a solids content of 60%

180 ml of water

The contents were ground at 300 rpm for 30 minutes. Thereafter, the balls were separated off. A 15.2 g quantity of n-propanol was added to obtain an inventive ink hereinafter also referred to as WF1.2.

### II. Production of Inventive Electrodes

II.1 Application of inventive ink WF1.1 and producing an inventive electrode Elektr.1

The substrate used was a glass fiber separator of the type 250 μm GF/F from Whatman. Then, inventive ink WF1.1 is sprayed with a spray gun on a vacuum table which had a temperature of 75° C. using nitrogen for spraying to obtain a catalyst loading of 5 mg/cm², reckoned on the sum total of (B.1), (C.1) and (D.1).

This was followed by a thermal treatment in an oven, temperature: 320° C. The polytetrafluoroethylene became soft at that temperature.

This gave an inventive electrode Elektr.1.

II.2 Application of inventive ink WF1.2 and producing an inventive electrode Elektr.2

Example II.1 was repeated with inventive ink WF1.2 to obtain an inventive electrode Elektr.2.

### III. Producing an Inventive Electrochemical Cell and Testing

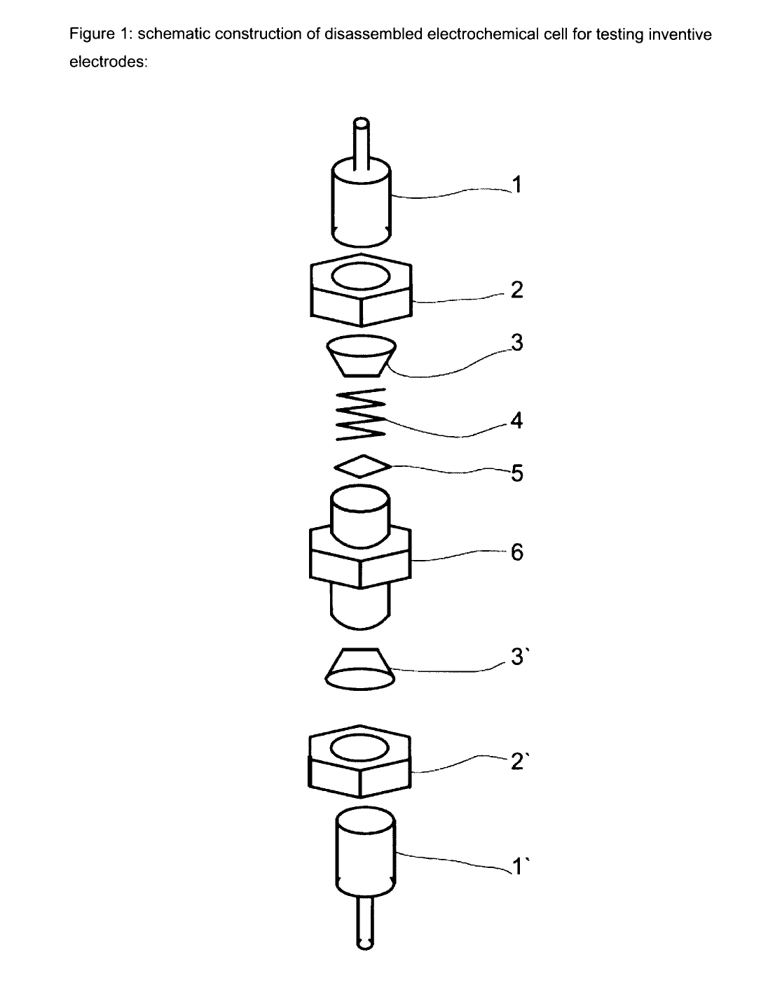

Electrochemical cells as per FIG. 1 were built for the electrochemical characterization of the inventive electrodes Elektr.1 and Elektr.2. The following materials were used for this as well as inventive electrodes:

Anode: lithium foil, 50 μm thick,

Separator: additional glass fiber separator, 150 μm thick, porous

Cathode according to Example II.

Electrolyte: 1 M LiPF6 in 1:1 ethylene carbonate/ethyl methyl carbonate.

The explanations in FIG. 1 mean:

1 plug with oxygen gas supply

1′ plug

2, 2′ washer

3, 3′ sealing ring—each in duplicate, the respectively second, somewhat smaller sealing ring is not shown here

4 spiral spring

5 current collector of nickel mesh

6 housing

This gave inventive electrochemical cell EZ.1 (based on inventive electrode Elektr.1) and inventive electrochemical cell EZ.2 (based on inventive electrode Elektr.2).

The inventive electrodes exhibited an open circuit potential of 3.0 to 3.2 volts. During discharging, the cell voltage dropped to 2.7 to 2.8 volts at a discharge current of 0.1 mA/cm². In the course of charging, the cell voltage rose to values between 3.6 and 4.4 V at a current density of 0.1 mA/cm². The inventive electrodes achieved more than 10 cycles in the electrochemical test cells (full cell).

1. A lithium air battery comprising at least one electrode comprising
(A) a solid medium through which gas can diffuse,
(B) at least one electrically conductive, carbonaceous material,
(C) at least one organic polymer,
(D) at least one compound of the general formula (I)
M¹ₐM²_{b}M³_{c}M⁴_{d}HₑO_{f} (I)
in particulate form, where the variables are each defined as follows:
M¹ is selected from Mo, W, V, Nb and Sb,
M² is selected from Fe, Ag, Cu, Ni, Mn and lanthanoids,
M³ is selected from B, C, N, Al, Si, P and Sn,
M⁴ is selected from Li, Na, K, Rb, Cs, Mg, Ca and Sr,
a is in the range from 1 to 3,
b is in the range from 0.1 to 10,
c is in the range from zero to one,
d is in the range from zero to one,
e is in the range from zero to 0.5,
f is in the range from 1 to 28,
and wherein compound of the general formula (I) has a BET surface area in the range from 1 to 300 m²/g.

2. The lithium air battery according to claim 1, wherein compound (D) is selected from mixed oxides and heteropolyacids and salts thereof.

3. The lithium air battery according to claim 1 or 2, wherein compound (D) is selected from Fe—Ag—X—O, Fe—V—X—O, Ag—X—V—O, Ce—X—O and Fe—X—O, where X is selected from molybdenum and tungsten.

4. The lithium air battery according to any of claims 1 to 3, wherein organic polymer (C) is selected from halogenated (co)polymers.

5. The lithium air battery according to any of claims 1 to 4, wherein solid medium (A) is selected from metal meshes, fibrous nonwoven webs or mats of glass fibers and gas diffusion media composed of carbon.

6. The lithium air battery according to any of claims 1 to 5, wherein electrically conductive, carbonaceous material (B) has a BET surface area in the range from 20 to 1500 m²/g.

7. The lithium air battery according to any of claims 1 to 6, wherein compound (D) has a mean primary particle diameter in the range from 10 to 50 nm.

8. The lithium air battery according to any of claims 1 to 7, wherein compound (D) is in the form of agglomerated particles, the agglomerates having a mean diameter of 20 nm to 50 μm.

9. The use of electrodes comprising
(A) a solid medium through which gas can diffuse,
(B) at least one electrically conductive, carbonaceous material,
(C) at least one organic polymer,
(D) at least one compound of the general formula (I)
M¹ₐM²_{b}M³_{c}M⁴_{d}HₑO_{f} (I)
in particulate form, where the variables are each defined as follows:
M¹ is selected from Mo, W, V, Nb and Sb,
M² is selected from Fe, Ag, Cu, Ni, Mn and lanthanoids,
M³ is selected from B, C, N, Al, Si, P and Sn,
M⁴ is selected from Li, Na, K, Rb, Cs, Mg, Ca and Sr,
a is in the range from 1 to 3,
b is in the range from 0.1 to 10,
c is in the range from zero to one,
d is in the range from zero to one,
e is in the range from zero to 0.5,
f is in the range from 1 to 28,
and wherein compound of the general formula (I) has a BET surface area in the range from 1 to 300 m²/g, in lithium air batteries.

10. The use according to claim 9, wherein organic polymer (C) is selected from halogenated (co)polymers.

11. The use according to claim 9 or 10, wherein solid medium (A) is selected from metal meshes, fibrous nonwoven webs or mats of glass fibers and gas diffusion media composed of carbon.

12. The use according to any of claims 9 to 11, wherein electrically conductive, carbonaceous material (B) has a BET surface area in the range from 20 to 1500 m²/g.

13. The use according to any of claims 9 to 12, wherein compound (D) has a mean primary particle diameter in the range from 10 to 50 nm.

14. The use according to any of claims 9 to 13, wherein compound (D) is in the form of agglomerated particles, the agglomerates having a mean diameter of 20 nm to 50 μm.

15. A process for operating equipment using lithium air batteries according to any of claims 1 to 8.
